(19) United States
(12) Patent Application Publication
(10) Pub. No.: US 2006/0179891 A1
(43) Pub. Date: Aug. 17, 2006

(54) Heating and drawing apparatus and method of manufacturing glass spacer using the same

(75) Inventor: Hideki Ishikawa, Hiratsuka-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/339,715

(22) Filed: Jan. 26, 2006

(30) Foreign Application Priority Data
Feb. 15, 2005 (JP) 2005-037048

(51) Int. Cl. C03B 37/02; C03B 37/025; C03B 37/00

(52) U.S. Cl. 65/435; 65/376

(57) ABSTRACT

A glass spacer having no swell at the end portions and no constriction at the middle portion and designed grooves is manufactured by a heating and drawing method. The heat flux output of a line heater for heating a glass base material in a wide area opposed to the glass base material is 95 to 105% of the heat flux output of the center portion in the longitudinal direction of the heater, and the glass base material is heated and drawn with the line heater at a viscosity of 10^{7.0} P or more and less than 10^{8.0} P.

### BACKGROUND OF THE INVENTION

1. Field of the Invention

The present invention relates to a heating and drawing apparatus for manufacturing a spacer which is interposed between a pair of substrates in an electronic or electric appliance to support the substrates, and to a method of manufacturing a glass spacer using the same. More specifically, it relates to a heating and drawing apparatus for a glass spacer which is used in a flat panel display and has parallel grooves for suppressing charging formed in a longitudinal direction, and to a method of manufacturing the glass spacer.

2. Related Background Art

The development of a flat panel display in which surface conduction electron-emitting devices are arranged in a matrix on a substrate, the substrate and a substrate having a phosphor are opposed to each other to form an airtight container (panel), and emitted electrons are applied to the phosphor to form an image is now under way.

In such a panel including electron-emitting devices which are arranged into the space between the pair of substrates, a spacer is interposed between the substrates so as to become an atmospheric pressure-resistant structure. As the method of manufacturing the spacer, a heating and drawing method of forming a glass base material having an oblong-rectangular section by heating and drawing is known. JP-A-2000-203857 (U.S. Pat. No. 6,385,998) discloses technology for improving the shape similarity of the obtained spacer to the base material and for preventing breakage at the time of drawing by specifying the viscosity of the glass base material at the time of heating and drawing.

As for the spacer for use in the above flat panel display, it is said that the spacer may be charged by collision of some electrons emitted from electron-emitting devices with the spacer or by adhesion of ions generated by a function of emitted electrons to the spacer. When the spacer is charged, the orbit of electrons emitted from the electron-emitting devices cannot be controlled precisely, thereby causing a problem such as a distortion of a displayed image.

To solve such a problem caused by the charging of the spacer, JP-A-2000-311608 (EP-A-1032014) proposes a spacer in which a plurality of grooves are formed in a direction parallel to a substrate on the surfaces to suppress charging. As a method of manufacturing the spacer, there is known a method of forming a spacer having a similar shape to that of a glass base material by heating and drawing the glass base material having grooves on the surfaces in advance.

A glass material is generally heated and drawn to ensure that the viscosity of the glass material becomes 10⁵ to 10¹⁰ P (poise, 1P=0.1 Pa·sec). When the viscosity of the glass material is set relatively low within the above range by increasing the heating temperature, as shown in FIG. 4, both the end portions in the longitudinal direction on the sectional form perpendicular to the drawing direction of the glass material tend to become round and swell. When the spacer having this shape is installed upright so as to be horizontally long on a substrate (the drawing direction is parallel to the substrate), as the contact surface of the spacer with the substrate is curved, the stability and the assembly efficiency of the panel lower and support strength is hardly obtained.

When the viscosity is set relatively high by reducing the heating temperature, as shown in FIG. 5, the middle portion in the longitudinal direction on the sectional form perpendicular to the drawing direction of the glass material is apt to be constricted. When the spacer having this shape is used, as the inside pressure of the panel is reduced, required atmospheric pressure-resistant supportability may not be obtained. Further, the spacer may be broken by tensile force for drawing.

Further, when the controllability of the sectional form of the spacer is low, in the case of a spacer having grooves which are formed on the surface in order to suppress charging, designed grooves are not obtained, thereby making it impossible to obtain a desired charging suppression effect.

### SUMMARY OF THE INVENTION

It is an object of the present invention to manufacture a highly-controllable spacer which solves the above problems and has grooves on a surface thereof in order to suppress charging, as designed.

According to a one aspect of the present invention, there is provided a method of manufacturing a glass spacer for use in a display device including the steps of: heating a glass base material having a oblong-rectangular section and a plurality of parallel grooves on at least one surface with a rectangular heater arranged to surround the glass base material; and drawing the glass base material at a viscosity of 10^{7.0} P or more and less than 10^{8.0} P, characterized in that the heat flux output of the heater in an area opposed to the glass base material is 95% or more and less than 105% of the heat flux output of the heater of a portion corresponding to the center portion of the glass base material.

Further, according to further aspect of the present invention, there is provided a heating and drawing apparatus for heating and drawing a glass base material having an oblong-rectangular section and a plurality of parallel grooves on at least one surface in a direction parallel to the grooves to manufacture a glass spacer having a similar section in shape to the section and grooves, characterized in that: the heating and drawing apparatus has a line heater extending in a longitudinal direction perpendicular to the drawing axis of the glass base material; and the heat flux output of the line heater in the area opposed to the glass base material is 95% or more and 105% or less of the heat flux output of the center portion of the line heater.

### BRIEF DESCRIPTION OF THE DRAWINGS

FIG. 1 is a schematic diagram showing a construction of a preferred embodiment of the heating and drawing apparatus of the present invention;

FIG. 2 is a sectional view perpendicular to a drawing direction of the heating and drawing apparatus of FIG. 1;

FIG. 3 is a perspective view of an example of a spacer obtained by the present invention;

FIG. 4 is a perspective view of an example of a spacer obtained by a conventional manufacturing method;

FIG. 5 is a perspective view of another example of the spacer obtained by a conventional manufacturing method:

FIG. 6 is a diagram showing the relationship between the viscosity of a glass base material and sagging of a corner portion of the obtained spacer at the time of drawing;

FIG. 7 is a diagram showing actual measurement values of depths of grooves of the spacer in examples of the present invention; and

FIG. 8 is a diagram showing heat flux output of a heater used in examples of the present invention.

### DESCRIPTION OF THE PREFERRED EMBODIMENTS

A new problem that when a spacer having a plurality of grooves on the surface is formed by heating and drawing, the sections of the grooves loose an original shape has been found through studies conducted by the inventors of the present invention. The cause of this is considered to be that when the glass base material having an oblong-rectangular section perpendicular to the drawing direction is heated, the quantity of heat received by the surface has a distribution in the longitudinal direction on the section.

For example, when a glass base material having an oblong-rectangular section is heated with a round ring heater, the middle portion in the longitudinal direction on the section is far from the heater as a heat source whereas both end portions are close to the heater and heated more than the intermediate portion. Therefore, when the entire section in the longitudinal direction of the glass base material is heated until predetermined viscosity at which the glass base material is easily drawn is obtained, both the end portions are heated excessively and the viscosity at these portions is reduced, whereby the grooves at both the end portions become shallower than the grooves at the middle portion.

A heating and drawing apparatus according to one aspect of the present invention includes a line heater which extends perpendicular to the drawing axis (drawing direction) of the glass base material and further controls the heat flux output of the heater in an area opposed to the glass base material to 95 to 105% of the heat flux output of the center portion of the heater. The viscosity distribution in the glass base material is suppressed by heating the glass base material at a fixed temperature, thereby making it possible to form grooves at high accuracy up to the end portions.

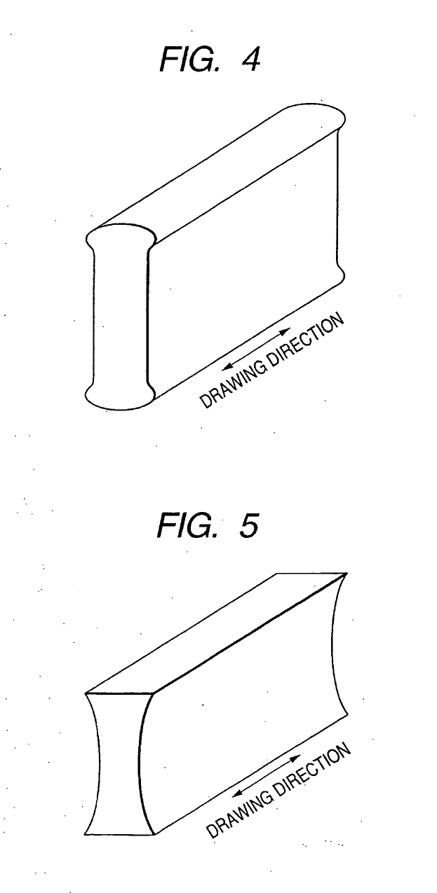

A method of manufacturing a glass spacer according to further aspect of the present invention is used to heat and draw the glass base material such that the viscosity of the glass base material becomes 10^{7.0} P or more and less than 10^{9.0} P. A glass spacer having an oblong-rectangular section without a swell at both end portions and a constriction at the middle portion as shown in FIG. 4 and FIG. 5 and designed grooves on the surfaces can be formed at high reproducibility.

The heating and drawing apparatus and the manufacturing method of the present invention will be described in detail hereinafter.

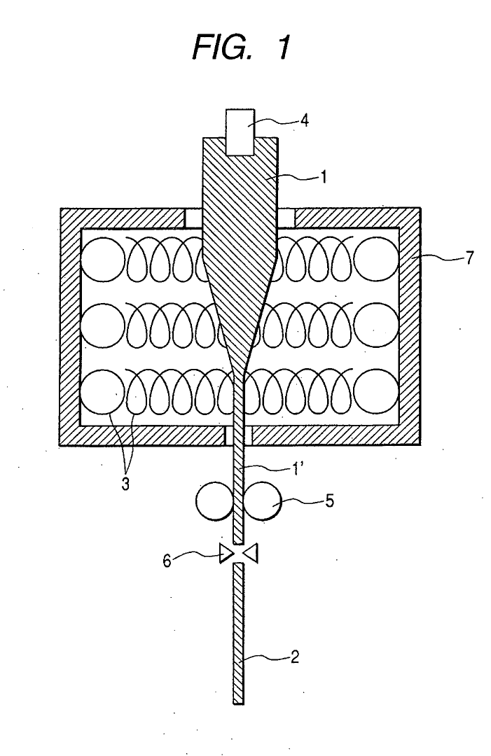

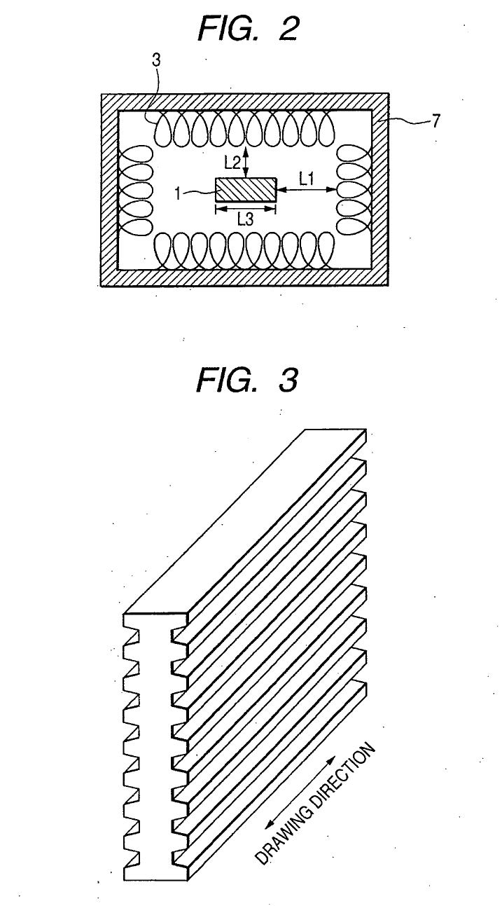

FIG. 1 is a schematic diagram showing the construction of a preferred embodiment of the heating and drawing apparatus of the present invention. FIG. 2 is a schematic sectional view perpendicular to the drawing direction of the apparatus. In these figures, reference numeral 1 denotes a glass base material; 1′, a heated and drawn glass base material; 2, a spacer; 3, a heater; and 4, a mechanical chucking mechanism. Numeral 5 denotes take-up rollers; 6, a cutter; and 7, a furnace casing.

In this embodiment, the section perpendicular to the drawing direction of the glass base material 1 is rectangular, preferably oblong-rectangular. A plurality of parallel grooves not shown for convenience perpendicular to the section (that is, parallel to the drawing direction) are formed on at least one surface, preferably surfaces parallel to the longitudinal direction of the section. The present invention is particularly preferably applied to a glass base material having such a section whose length in the longitudinal direction is 5 times or more the length in the transverse direction. The oblong-rectangular section of the glass base material in the present invention may be one having four right-angled corners or one having chamfered corners or rounded (R-finished) corners. The sectional form of the plurality of grooves formed on the surfaces of the glass base material is not particularly limited and may be rectangular, trapezoidal, semi-circular, or triangular and suitably selected according to the charging suppression effect of the completed spacer 2 after drawing as disclosed by JP-A-2000-311608. FIG. 3 shows an example of a spacer having grooves each with a trapezoidal section. Since the spacer having grooves each with a trapezoidal section can make the incident angle of electrons applied to the surfaces of the spacer small, it has a great charging suppression function and is preferably used as an atmospheric pressure-resistant structure in a panel.

In the heating and drawing method, the depths of the grooves in the drawn base material 1′ become smaller than the calculated transformation ratio and the slope angle becomes gentle owing to reduction in the viscosity of the base material at the time of heating and drawing. When the viscosity of the base material at the time of heating and drawing is too high, the heated and drawn glass base material 1′ is broken during drawing which is not preferable.

In the present invention, the base material 1 is heated to such an extent that the viscosity of the base material 1 at the time of drawing becomes 10^{7.0} P or more and less than 10^{8.0} P to thereby solve the above problem. In order to heat the glass base material 1 uniformly to achieve the above range of viscosity for the glass base material 1, it is important that the heat flux output of a line heater should be controlled as desired. Stated more specifically, the base material is heated and drawn by controlling the heat flux output of the heater in an area opposed to the base material to 95% or more and 105 % or less of the heat flux output of the heater of a portion corresponding to the center portion of the base material.

In the heating and drawing apparatus of the present invention, distances L1 and L2 from the heater 3 to the surfaces of the glass base material 1 are preferably equal to each other, more preferably equal to the length L3 in the longitudinal direction of the section of the glass base material 1.

In the embodiment shown in FIG. 1, the glass base material 1 is fastened to and supported with the mechanical chucking mechanism 4 so that the surfaces of the glass base material 1 become parallel to the line heater 3. The lower portion of the base material is heated by the heater 3 to be softened and drawn, and the drawn lower portion of the drawn glass base material 1′ is sandwiched between the take-up rollers 5. In this state, the take-up rollers 5 are turned while the mechanical chucking mechanism 4 is gradually moved down to take up the drawn glass base material 1′ at a take-up speed higher than the descending speed of the mechanical chucking mechanism 4. Then, the drawn glass base material 1′ having a similar section form to that of the glass base material 1 softened by heating at the drawing temperature is continuously formed owing to a speed difference between the descending speed of the mechanical chucking mechanism 4 and the take-up speed of the take-up rollers 5. The drawn glass base material 1′ having passed between the take-up rollers 5 in a cooled and solidified state is cut with the cutter 6 to thereby obtain a plate-like or columnar glass spacer 2 having a plurality of parallel grooves on the surface and a similar section to that of the glass base material 1.

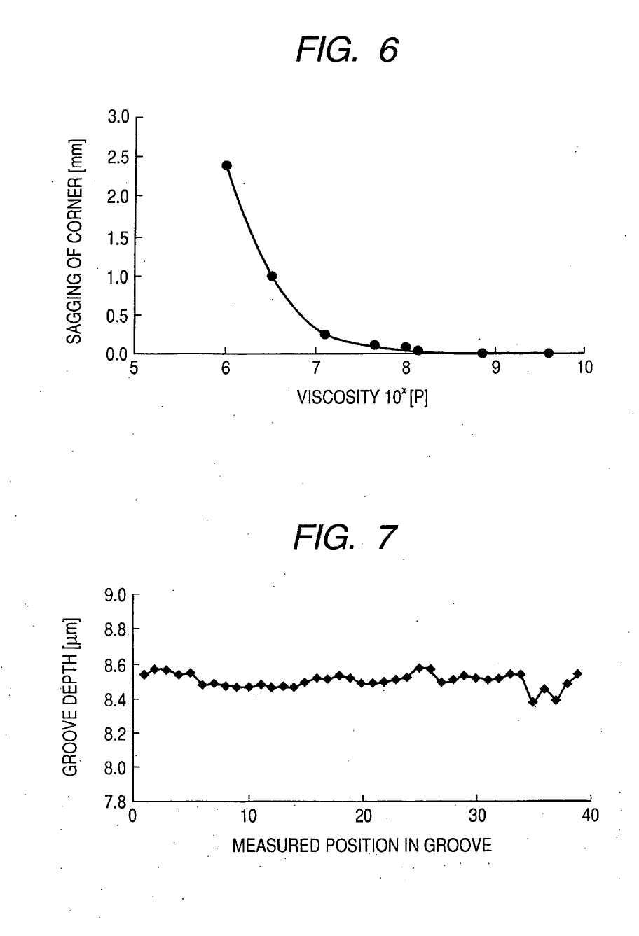

In the present invention, when the viscosity of the glass base material 1 is 10^{7.0} P or more, the influence of the sagging of the glass base material softened by heating becomes small and the shape controllability of the spacer 2 becomes high. FIG. 6 shows the relationship between the viscosity of the glass base material 1 and the sagging of each corner of the spacer 2 at the time of drawing.

As shown in Table 1 below, when the viscosity of the glass base material is 10^{7.5} P or more, changes (distribution) in the depths of the grooves on the surface become small, thereby obtaining a stable shape advantageously.

TABLE 1

| | Depth of groove | |
|---|---|---|
| | of spacer (actual | |
| Viscosity of | measurement | |
| glass base | value/theoretical | |
| material 10^{x} [P] | value) × 100 [%] | Remarks |
| 8.1 | 90.5* | Broken at the |
| | | time of drawing |
| 7.9 | 90.3 | — |
| 7.6 | 89.0 | — |
| 7.5 | 88.5 | — |
| 7.4 | 87.0 | — |
| 7.3 | 85.3 | — |
| 7.2 | 83.2 | — |
| 7.1 | 80.5 | — |

*The grooves of the glass base material after drawing were measured.

Further, when productivity is taken into consideration, it is desired that the take-up speed of the take-up rollers 5 should be 1,500 mm/min or more. Since the drawn glass base material 1′ is broken very often at the time of drawing when the viscosity of the glass base material 1 is 10^{8.0} P or more in consideration of the above speed, the glass base material 1′ should be taken up at a viscosity of less than 10^{8.0} P.

### EXAMPLES

### Example 1

A glass base material having an oblong-rectangular section measuring 6.15 mm×49.23 mm and 40 trapezoidal grooves with a depth of 0.335 mm and a pitch of 0.923 mm on the surface was used. The heating and drawing apparatus shown in FIG. 1 was used. A heater 3 opposed to the longitudinal direction (49.23 mm) of the above section had a length of 130 mm, and a heater 3 opposed to the transverse direction (6.15 mm) of the section had a length of 86 mm. These heaters were each arranged at positions about 49 mm away from the surfaces of the glass base material. The centers in the longitudinal direction of the heaters 3 were aligned with each other in each direction. In other word, the base material is positioned with respect to the heaters in such a manner that the center of each side of the base material is aligned with the center of the side of the heater opposed to the side of the base material.

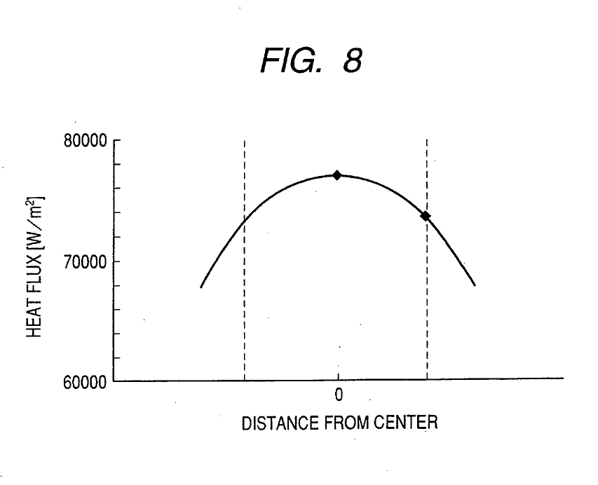

FIG. 8 shows the heat flux output of a 130 mm-long heater 3 which has heated the glass base material 1 at 780° C. When the heat flux output of the heater close to a position corresponding to the center in the longitudinal direction of the glass base material 1 was measured, it was about 77,000 W/m². In this case, when the heat flux output of the heater at positions (indicated by dotted lines shown in FIG. 8) 24.6 mm outward from the center, corresponding to the end portions of the glass base material 1 was measured, it was about 73,200 W/m², 95% of the output at a position near the center.

Similarly, the heat flux output of the center portion of the heater 3 in the transverse direction was 77,000 W/m², and the heat flux output of the heater 3 in an area opposed to the glass base material 1 and a portion therearound was 77,000 to 73,200 W/m², 95% to 105% or less of the value at the center.

The above glass base material 1 is introduced into the inside of the furnace by moving down the mechanical chucking mechanism 4 at a speed V1 of 2.5 mm/min. The glass base material 1 was heated at about 780±3° C. (the viscosity of the glass base material at this temperature=10^{7.5} P) by installing the above heaters at the above positions. The base material was taken up by the take-up rollers 5 installed below the heaters 3 at a speed V2 approximately 2,700 mm/min to thereby be heated and drawn. Finally, the base material was cut with the cutter 6 to a length of 850 mm. The sectional area S2 perpendicular to the drawing direction of the obtained spacer 2 was about 0.32 mm² (0.2 mm×1.6 mm), the pitch of the grooves on the surface was 30 μm, and the depths of the grooves were 8.5 μm±0.15 μm. The grooves were uniform in shape with a variation of 1.8% or less. FIG. 7 shows the actual measurement values of the depths of the grooves on one surface.

The distortion of an image was not observed on a display constructed by using the spacer of Example 1, and high image quality was obtained.

### Example 2

The same heating and drawing apparatus as that of Example 1 was used to manufacture a spacer 2 in the same manner as in Example 1 except that the viscosity of the glass base material was set to 10^{7.6} P and 10^{7.9} P by reducing the drawing temperature. As a result, a high-quality spacer was obtained as in Example 1 when drawing was carried out at these viscosities.

### Comparative Example

When the same heating and drawing apparatus as that of Example 1 was used to manufacture a spacer 2 in the same manner as in Example 1 except that the viscosity of the glass base material was set to 10^{8.1} P by reducing the drawing temperature, the drawn glass base material 1′ was broken between the furnace casing 7 and the take-up rollers 5 while it was drawn. Therefore, a spacer could not be obtained.

### Example 3

The same heating and drawing apparatus as that of Example 1 was used to manufacture a spacer 2 in the same manner as in Example 1 except that the viscosity of the glass base material was set to 10^{7.1} P and 10^{7.3} P by increasing the drawing temperature. Although the temperature of the glass base material could be made uniform at high accuracy in Example 3 as well, the drawing temperature was raised by increasing the temperatures of the heaters, thereby reducing the viscosity of the glass base material. This resulted in a variation in the depths of the grooves of about 3% for respective viscosities. However, the distortion of an image was not observed on a display employing this spacer, and high image quality could be obtained.

Examples of the present invention have been described above. In the above-described examples, the heater and the base material are arranged such that the center of the heater and the center of the base material are aligned with each other. The present invention is not limited to this. That is, even when the center of the base material is not aligned with the center of the heater, the heat flux output of the heater in the area opposed to the base material may be 95% or more and 105% or less of the heat flux output of the heater of a portion corresponding to the center of the base material. That is, for the heater of Example 1, if the center portion of the base material is not aligned with the center portion of the heater, the temperature of the center portion of the base material becomes lower than the temperature of one end portion of the base material and higher than the temperature of the other end of the base material. In this case, the heat flux output of the heater of a portion corresponding to the center portion of the base material becomes lower than the heat flux output of the heater of a portion corresponding to one end portion of the base material and higher than the heat flux output of the heater of a portion corresponding to the other end portion of the base material. However, even in this case, when the heat flux output of the heater in the area opposed to the base material is 95% or more and 105% or less of the heat flux output of the heater of a portion corresponding to the center portion of the base material, a spacer reflecting the shape of the base material accurately can be obtained.

According to the present invention, a spacer having the high controllability of its sectional form and desired grooves can be manufactured by the heating and drawing method at high reproducibility and high accuracy. Therefore, a spacer having an excellent charging suppression effect can be provided at a low cost, and a flat panel display having excellent display characteristics can be constructed.

This application claims priority from Japanese Patent Application No. 2004-0370.48 filed on Feb. 15, 2005, which is hereby incorporated by reference herein.

What is claimed is:

1. A method of manufacturing a glass spacer for use in a display device, comprising the steps of:
heating a glass base material having an oblong-rectangular section and a plurality of parallel grooves on at least one surface with a rectangular heater arranged to surround the glass base material; and
drawing the glass base material at a viscosity of the glass base material of 10^{7.0} P or more and less than 10^{8.0} P,
wherein heat flux output of the heater in an area opposed to the glass base material is 95 % or more and less than 105% of heat flux output of the heater of a portion corresponding to a center portion of the glass base material.

2. A method of manufacturing a glass spacer according to claim 1, wherein the glass base material is drawn at a viscosity of the glass base material of 10^{7.5} P or more and less than 10^{8.0} P.

3. A method of manufacturing a glass spacer according to claim 1, wherein the rectangular heater is provided at a distance equal to a length in a longitudinal direction of a section perpendicular to a drawing axis of the glass base material from a surface of the glass base material.

4. A heating and drawing apparatus for heating and drawing a glass base material having an oblong-rectangular section and a plurality of parallel grooves on at least one surface in a direction parallel to the grooves to manufacture a glass spacer having a similar section in shape to the section and grooves, wherein:
the heating and drawing apparatus has a line heater extending in a longitudinal direction perpendicular to a drawing axis of the glass base material; and
heat flux output of the line heater in an area opposed to the glass base material is 95% or more and 105% or less of the heat flux output in a center portion of the line heater.
